(19) United States
(12) Patent Application Publication
(10) Pub. No.: US 2019/0166424 A1
(43) Pub. Date: May 30, 2019

(54) MICROPHONE MESH NETWORK

(71) Applicant: INVENSENSE, INC., San Jose, CA (US)

(72) Inventors: Kieran Harney, Rockport, MA (US); Mark Kusch, Newton, MA (US); Jeremy Parker, Chelmsford, MA (US)

(21) Appl. No.: 15/990,103

(22) Filed: May 25, 2018

Related U.S. Application Data
(60) Provisional application No. 62/591,377, filed on Nov. 28, 2017.

(51) Int. Cl. H04R 3/00; H04R 1/40

(52) U.S. Cl. CPC H04R 3/005; G06K 9/00221; H04R 1/406

(57) ABSTRACT

The present invention relates to systems and methods for operating a microphone mesh network. In one embodiment, a method includes connecting, via a device comprising a processor, to one or more active microphones in an area via a network; instructing, via the device, one or more selected microphones of the one or more active microphones to capture audio from an acoustic source; and receiving, via the device, the audio from the one or more selected microphones as input to one or more applications.

### CROSS-REFERENCE TO RELATED APPLICATIONS

The present application claims the benefit of priority to U.S. Provisional Patent Application No. 62/591,377, filed Nov. 28, 2017, and entitled “MICROPHONE MESH NETWORK,” the entirety of which application is incorporated herein by reference.

### BACKGROUND

Advancements in electronic device technology, and in particular voice control, have resulted in an explosion in the use of microphones in the marketplace. For instance, devices such as smart speakers are now driving the use of microphones as an audio interface for voice commands. Additionally, many internet of things (IoT) devices are now also being developed with microphones for voice commands and/or other uses. Further, there has been significant growth in the number of microphones associated with traditional microphone-enabled devices such as mobile phones, as demands for increased voice quality and/or other advancements have led to the use of microphone arrays in such devices that can in some cases include three or more microphones.

### BRIEF DESCRIPTION OF THE DRAWINGS

FIG. 1 is a block diagram of a system facilitating a microphone mesh network in accordance with one or more embodiments of the disclosure.

FIG. 2 is a block diagram of a system facilitating establishment and maintenance of a microphone mesh network in accordance with one or more embodiments of the disclosure.

FIG. 3 is a block diagram of a system facilitating device positioning in a microphone mesh network in accordance with one or more embodiments of the disclosure.

FIGS. 4-5 are block diagrams of respective systems facilitating acoustic source positioning and microphone selection in accordance with one or more embodiments of the disclosure.

FIG. 6 is a block diagram of a system facilitating image-assisted positioning in a microphone mesh network in accordance with one or more embodiments of the disclosure.

FIG. 7 is a block diagram of a system facilitating data encryption and security in a microphone mesh network in accordance with one or more embodiments of the disclosure.

FIG. 8 is a block diagram of a system facilitating smart device activation via a microphone mesh network in accordance with one or more embodiments of the disclosure.

FIGS. 9-10 are diagrams depicting respective environments in which a microphone mesh network can be deployed in accordance with one or more embodiments of the disclosure.

FIG. 11 is a flow diagram of a method facilitating operation of a microphone mesh network in accordance with one or more embodiments of the disclosure.

FIG. 12 is a diagram of an example computing environment in which various embodiments described herein can function.

### SUMMARY

The following presents a simplified summary of one or more of the embodiments of the present invention in order to provide a basic understanding the embodiments. This summary is not an extensive overview of the embodiments described herein. It is intended to neither identify key or critical elements of the embodiments nor delineate any scope of embodiments or the claims. This Summary's sole purpose is to present some concepts of the embodiments in a simplified form as a prelude to the more detailed description that is presented later. It will also be appreciated that the detailed description may include additional or alternative embodiments beyond those described in the Summary section.

The present disclosure recognizes and addresses, in at least certain embodiments, the issue of reducing cost and/or complexity of microphone systems associated with voice-controlled devices such as smart speakers, IoT devices, etc. In general, existing microphone-enabled devices utilize one or more local (internal) microphones for voice input. For instance, smart speaker devices can utilize a local microphone for voice control and/or other uses. Similarly, audio/video communication and/or conferencing applications generally utilize a single centralized device, e.g., a telephone or other dedicated microphone device, to facilitate voice communication between parties to the conference.

However, local microphones can encounter difficulty in distinguishing desired acoustic inputs, e.g., a desired speaker's voice, from background acoustics such as music, feedback, echo, or the like. Further, this difficulty increases as background acoustics increase in volume relative to the desired acoustic input. Additionally, conventional microphone-enabled devices are limited by the range of their associated local microphone(s) and encounter similar difficulty in receiving desired acoustic input as the distance between the local microphone(s) and the acoustic source increases. This difficulty can result in reduced audio quality for voice conferencing and reduced voice command recognition accuracy at a voice-activated device, among other adverse effects.

To offset these adverse effects, some conventional microphone-enabled devices utilize costly high-precision microphones and/or microphone arrays as well as complex beamforming and/or noise canceling algorithms. In contrast, various aspects described herein provide a framework by which microphones associated with respective devices in a room or other area can interface with each other via a network, referred to herein as a microphone network or a microphone mesh network, such that a device can utilize microphones that are not physically or locally associated with the device, e.g., microphones associated with other devices in the area, for acoustic input when appropriate.

In one aspect disclosed herein, a computer-implemented method includes connecting, via a device including a processor, to one or more active microphones in an area via a network, instructing, via the device, one or more selected microphones of the one or more active microphones to capture audio from an acoustic source, and receiving, via the device, the audio from the one or more selected microphones as input to one or more applications.

In another aspect disclosed herein, a device includes one or more processors, a transceiver operatively coupled to the one or more processors, and a memory operatively coupled to the one or more processors. Computer executable instructions are stored on the memory which, when executed by the one or more processors, cause the one or more processors to connect to one or more active microphones in an area via the transceiver over a network, identify an acoustic source in the area, instruct one or more selected microphones of the one or more active microphones to capture audio from the acoustic source, and receive, via the transceiver, the audio from the one or more selected microphones as input to one or more applications.

In still another aspect disclosed herein, a computer program product for managing a microphone mesh network includes a non-transitory computer readable storage medium on which program instructions are stored. The program instructions are executable by a processor to cause the processor to connect to one or more active microphones in an area via the transceiver over a network, identify an acoustic source in the area, instruct one or more selected microphones of the one or more active microphones to capture audio from the acoustic source, and receive, via the transceiver, the audio from the one or more selected microphones as input to one or more applications.

Other embodiments and various examples, scenarios and implementations are described in more detail below. The following description and the drawings set forth certain illustrative embodiments of the specification. These embodiments are indicative, however, of but a few of the various ways in which the principles of the specification may be employed. Other advantages and novel features of the embodiments described will become apparent from the following detailed description of the specification when considered in conjunction with the drawings.

### DETAILED DESCRIPTION

The present disclosure recognizes and addresses, in at least certain embodiments, the issue of reducing cost and/or complexity of microphone systems associated with voice-controlled devices such as smart speakers, IoT devices, etc. In general, existing microphone-enabled devices utilize one or more local (internal) microphones for voice input. For instance, smart speaker devices can utilize a local microphone for voice control and/or other uses. Similarly, audio/video communication and/or conferencing applications generally utilize a single centralized device, e.g., a telephone or other dedicated microphone device, to facilitate voice communication between parties to the conference.

However, local microphones can encounter difficulty in distinguishing desired acoustic inputs, e.g., a desired speaker's voice, from background acoustics such as music, feedback, echo, or the like. Further, this difficulty increases as background acoustics increase in volume relative to the desired acoustic input. Additionally, conventional microphone-enabled devices are limited by the range of their associated local microphone(s) and encounter similar difficulty in receiving desired acoustic input as the distance between the local microphone(s) and the acoustic source increases. This difficulty can result in reduced audio quality for voice conferencing and reduced voice command recognition accuracy at a voice-activated device, among other adverse effects.

To offset these adverse effects, some conventional microphone-enabled devices utilize costly high-precision microphones and/or microphone arrays as well as complex beamforming and/or noise canceling algorithms. In contrast, various aspects described herein provide a framework by which microphones associated with respective devices in a room or other area can interface with each other via a network, referred to herein as a microphone network or a microphone mesh network, such that a device can utilize microphones that are not physically or locally associated with the device, e.g., microphones associated with other devices in the area, for acoustic input when appropriate.

In an aspect, benefits of the embodiments disclosed herein can include the following: Reliance of a device upon expensive microphones with dedicated complex beamforming and/or noise cancelling algorithms can be reduced. Audio quality in audio and/or video conferencing applications can be improved. Accuracy of voice commands recognized by a smart speaker application, such as “barge-in” commands or the like, can be increased. Other benefits can also be realized.

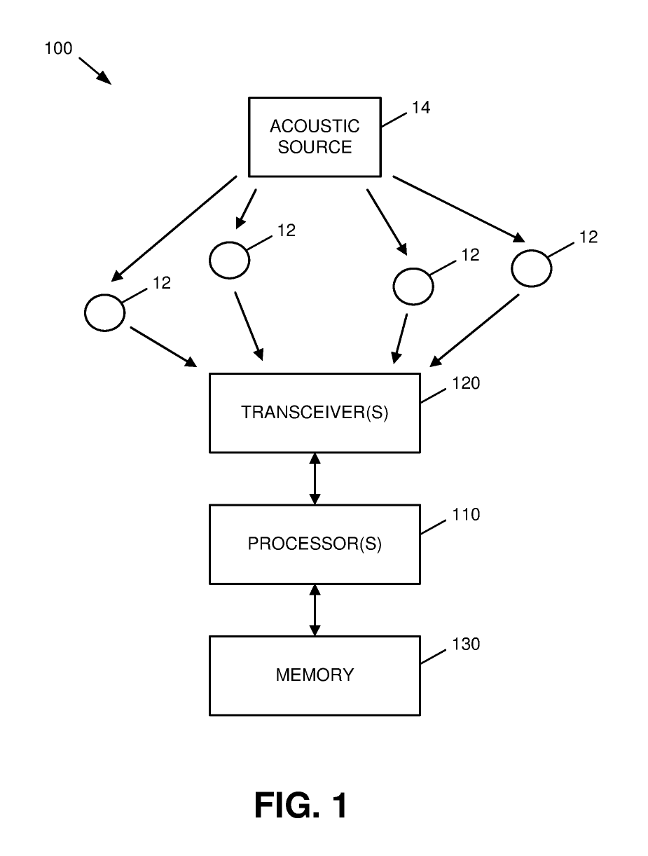

With reference now to the drawings, FIG. 1 illustrates a system 100 that facilitates a microphone mesh network in accordance with one or more embodiments described herein. The system 100 includes a device that includes one or more processors 110, a transceiver 120 operatively coupled to the one or more processors 110, and a memory 130 operatively coupled to the one or more processors 110. The memory 130 has stored thereon computer executable instructions which, when executed by the one or more processors 110, cause the one or more processors 110 to connect to one or more active microphones 12 in an area via the transceiver 120 over a network, identify an acoustic source 14 in the area, instruct one or more selected microphones of the one or more active microphones 12 to capture audio from the acoustic source 14, and receive, via the transceiver 120, the audio from the one or more selected microphones as input to one or more applications. In an aspect, the transceiver 120 can be, or include the functionality of, any hardware and/or software components that facilitate communication between devices via any suitable wired and/or wireless communication technology or combination or technologies either presently existing or developed in the future.

In respective ones of the embodiments that follow, various aspects of the disclosed subject matter are shown and described using functional language, e.g., in terms of various modules and/or components. It should be appreciated that respective functional elements of the various embodiments disclosed herein can be implemented in hardware, software, and/or a combination of hardware and software. For instance, one or more modules and/or components as described herein can be implemented via computer-executable instructions that are stored on a memory (e.g., memory 130 in system 100) and executed by a processor (e.g., processor(s) 110 in system 100). Other configurations are also possible, as will be discussed in further detail below.

Additionally, the term “acoustic” as used herein is intended to refer to any waveform and/or other means by which sound can be transmitted through a medium. While respective examples herein relate to voice audio as an acoustic signal, it should be appreciated that various aspects of the disclosed subject matter can utilize and/or process any suitable acoustic waveforms, which can be composed wholly or in part via any infrasonic, sonic, and/or ultrasonic frequencies or any combination thereof. Unless explicitly stated otherwise in the context of a particular embodiment, the scope of an acoustic source and/or signal as described herein is intended to encompass all appropriate infrasonic, sonic, and/or ultrasonic frequencies.

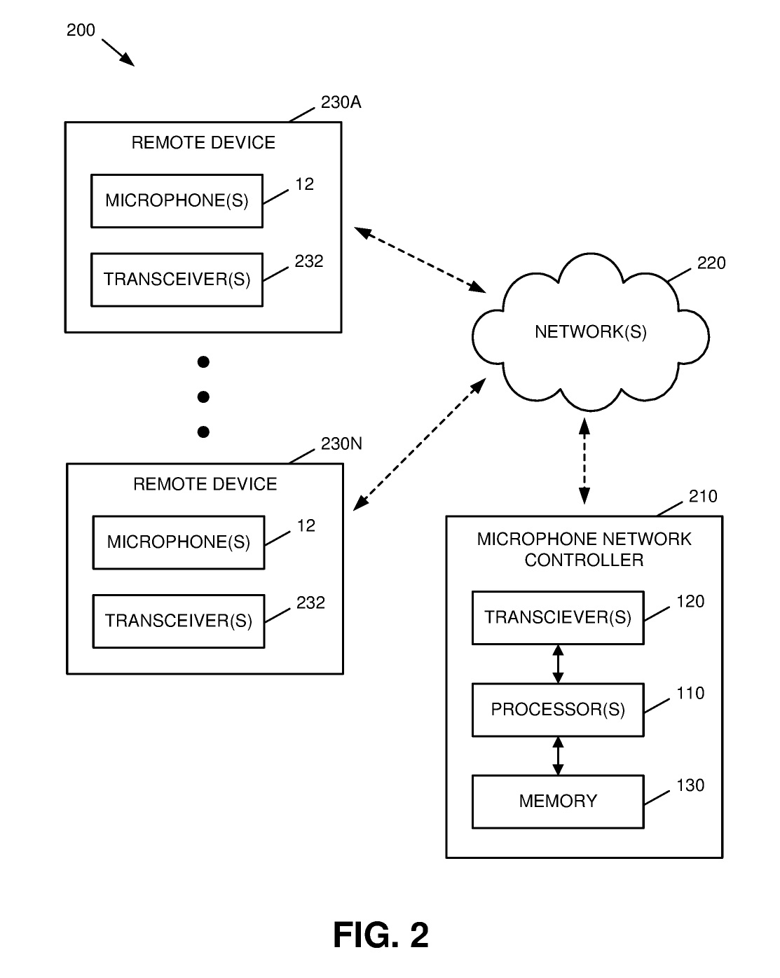

Turning next to FIG. 2, a block diagram of a system 200 that facilitates establishment and maintenance of a microphone mesh network in accordance with one or more embodiments of the disclosure is illustrated. Repetitive description of like parts discussed in previous embodiments is omitted for brevity. As shown in FIG. 2, system 200 includes a microphone network controller 210, also referred to herein as simply a “controller,” that utilizes one or more processors 110, transceivers 120, and/or memory 130 in a similar manner to that described above with respect to system 100. In an aspect, the controller 210 can be configured to communicate via one or more communication networks 220 with respective remote devices 230.

In an aspect, the controller 210 can be a dedicated device, e.g., a device including specialized hardware for implementing one or more embodiments as described herein. Also or alternatively, the controller 210 can be implemented via one or more computing devices such as a network router, a personal or laptop computer, a mobile phone, or the like. Regardless of the specific implementation of the controller 210, the controller 210 can provide an interface, via a software application and/or other means, which enables user configuration of various functions of the controller 210. In an aspect, the functionality of the controller 210 can also be divided among multiple devices, e.g., among multiple computers in a network, cluster, or other configuration, which can each perform respective functions associated with the controller 210. In another aspect, system 200 could utilize a decentralized architecture, in which respective remote devices 230 in system 200 can be configured to act as the controller 210 in addition to, or in place of, a dedicated controller device.

In an aspect, the network 220 can provide a means by which respective devices of 200 can communicate with each other. The network 220 can utilize any suitable wired and/or wireless communication technologies presently known or existing in the future or any suitable combination of such technologies. For instance, the network 220 can facilitate communication between devices via a low-power wireless network technology such as Bluetooth.

Also or alternatively, a wireless technology employed by the network 220 can include one or more procedures useful for connecting microphone-enabled devices such as the remote devices 230. These procedures can provide mechanisms for controlling access to devices based on authorization, e.g., authorization to use a given device and/or its microphone(s). Access to respective devices can be further made dependent on user consent; for instance, a connection between the controller 210 and a remote device 230 can be made dependent on receiving express consent from a user of the remote device 230 (e.g., by a user affirmatively “opting in” a device to the network 220 via a prompt at the device or by other means). Other permissions or additional factors that could affect the availability of respective remote devices 230 to the controller 210 can also be considered. In an aspect, authorization to connect a remote device 230 can be a general authorization or a limited authorization, e.g., such that a remote device 230 and/or its respective microphones 12 can be authorized for use on a per-device, per-application, and/or other limited basis.

Respective remote devices 230 in system 200 can be any devices that utilize microphones 12 for acoustic input for any suitable use, such as voice control, communication, or the like. Remote devices 230 in system 200 could include, but are not limited to, mobile phones, smart speakers, microphone-equipped computers, internet of things (IoT) devices such as smart appliances, thermostats, remote controls, televisions, etc., and/or any other suitable device(s).

In an aspect, respective remote devices 230 in system 200 can include one or more transceivers 232 that facilitate communication of information, including acoustic data obtained via an associated microphone 12, to one or more mother devices in system 200 via the network(s) 220. Alternatively, one or more remote devices 230 in system 200 can be configured without a transceiver 232 or other network communication ability. For instance, the remote devices 230 could include a standalone microphone 12 or another devices that lacks its own network communication functionality. In such a case, a remote device 230 can connect to the controller 210 and/or another remote device 230 that includes a transceiver 232 via a wired audio connection and/or other means. Similarly, one or more remote devices 230 of system 200 could lack local microphones 12 but instead receive acoustic information from one or more other remote devices 230 and relay the received information via a transceiver 232.

In an aspect, the controller 210 can initiate connection with one or more remote devices 230 in system 200 by polling respective devices in the area, e.g., by broadcasting and/or otherwise transmitting a polling signal over the network(s) 220 in order to identify respective available devices in the area. In response to identifying respective available devices, the controller 210 can establish connections with the available devices using a pairing technique, such as a pairing technique similar to that utilized in the Bluetooth wireless communication standard, and/or by any other suitable means.

In another aspect, respective remote devices 230, upon receiving a polling signal (e.g., from the controller 210), can determine whether connection to the controller 210 is authorized, either in general or for one or more uses indicated by the controller 210, based on device security settings, user consent and/or other user preferences, and/or other factors. Based on these factors, a remote device 230 can be configured to indicate availability for connection to the controller 210 only when authorized to do so.

A remote device 230, once paired to the controller 210, can be configured to actively initiate reconnection with the controller 210 after becoming available following a period of unavailability (e.g., when the remote device 230 is powered on, comes into communication range of the controller 210, etc.). Alternatively, the controller 210 can undergo polling and pairing operations as described above on an ongoing basis, e.g., periodically, to discover and connect to new remote devices 230 in the area.

In a further example, respective remote devices 230 can connect to each other independently of the controller 210 using similar techniques to those described above with respect to connections between remote devices 230 and the controller 210. In an example where remote devices 230 connect to each other independently of the controller 210, one or more of the connected remote devices 230 can subsequently connect some or all of the connected remote devices 230 with the controller 210 via the pre-established connections between the remote devices 230 either directly or indirectly. This could be used, for example, in implementations where a first remote device 230 is out of range of the controller 210 but in range of a second remote device 230, implementations where a remote device 230 utilizes a communication protocol not supported by the controller 210, and/or other implementations.

In still another example, the controller 210 and/or remote devices 230 can connect to each other in an ad-hoc manner without the use of an intervening network 220. In such a case, the controller 210 and remote device(s) 230 can communicate directly with each other according to one or more wired or wireless communication standards.

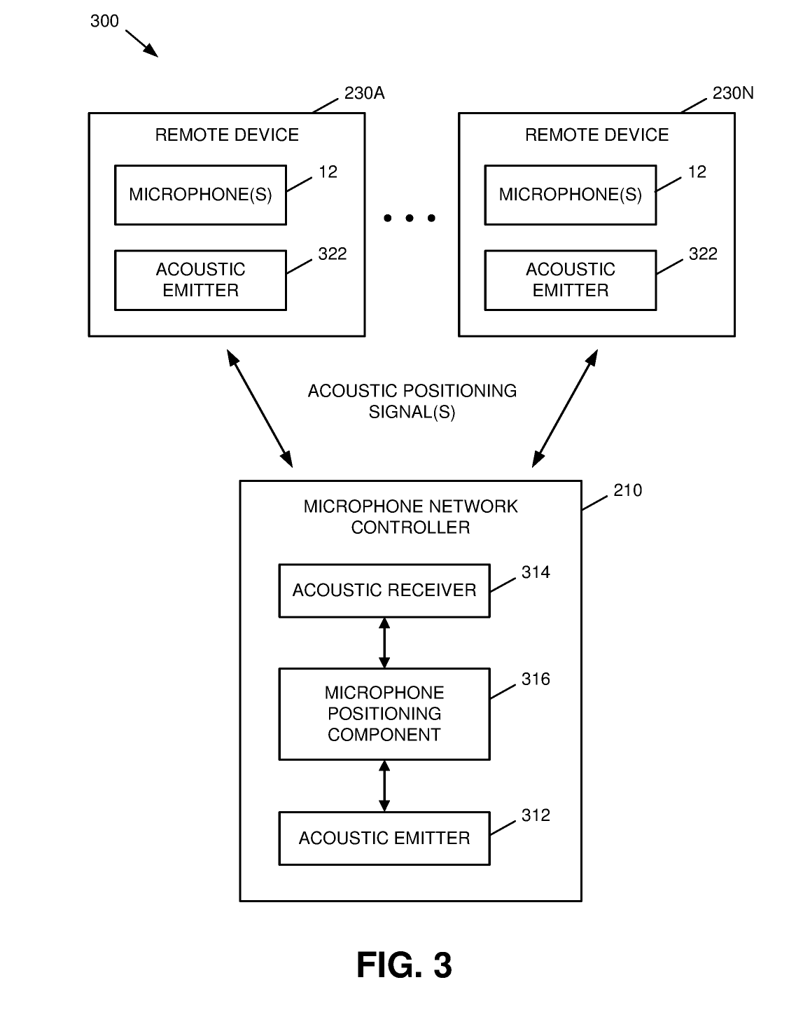

With reference now to FIG. 3, a block diagram of a system 300 that facilitates device positioning in a microphone mesh network in accordance with one or more embodiments of the disclosure is illustrated. Repetitive description of like parts discussed in previous embodiments is omitted for brevity. As shown by FIG. 3, system 300 includes a microphone network controller 210 that can be connected, e.g., via one or more networks 220, to respective remote devices 230 as generally described above with respect to system 200. The remote devices 230, in turn, can be associated with respective active microphones 12 that make up the microphone mesh network managed by the controller 210.

In an aspect, the controller 210 can be configured to determine positions of active microphones 12 in the area, e.g., microphones associated with the remote devices 230, via acoustic positioning. Acoustic positioning can be performed, for instance, to improve performance of the system and facilitate selection of appropriate microphones in the area for a given application. In one example, the controller 210 can initialize acoustic positioning within system 300 by transmitting a “ping” signal and/or other appropriate acoustic information via an acoustic emitter 312. The acoustic emitter 312 can be a speaker and/or any other device that is suitable for generating acoustic waves at a desired frequency or set of frequencies. Additionally, the acoustic signal emitted by the controller 210 via the acoustic emitter 312 can be of any suitable infrasonic, sonic, or ultrasonic frequency or any combination of such frequencies.

Once transmitted via the acoustic emitter 312 of the controller 210, the controller 210 can estimate distances from respective ones of the remote devices 230 and/or active microphones 12 based on timing information associated with the transmitted positioning signal. In one example, the remote devices 230 can actively receive signals transmitted by the controller 210 via microphones 12 associated with the respective remote devices 230 and transmit a responsive signal via an associated acoustic emitter 322 in a similar manner to the acoustic emitter 312 of the controller 310. The controller 210 can receive these responsive signals via an acoustic receiver 314, which can itself be a microphone and/or any other device(s) suitable for receiving and interpreting acoustic information. In response to receiving signals from the remote device(s) 230, the controller 210 can estimate the placement of the remote device(s) 230 relative to the controller 210 and the surrounding area based on an elapsed time between transmitting the positioning signal and receiving the responsive signal.

In an aspect, the above active positioning technique can be utilized to identify microphones 12 in the area that are active. For instance, a remote device 230 can be configured to respond to a positioning signal from the controller 210 only if the device 230 and/or its microphones 12 are authorized to connect to the controller 210. In a further aspect, the positioning signal(s) utilized by the controller 210 and/or remote device(s) 230 can be modulated and/or otherwise encoded with additional information regarding specific applications, devices, etc., such that the controller 210 and remote devices 230 can establish authorization on a granular basis. Alternatively, this additional information can be transmitted via other means (e.g., by radio messages transmitted via the network(s) 220) in addition to the positioning signals.

In another example, the controller 210 can estimate positions of microphones 12 and/or remote devices 230 in the area passively by broadcasting an acoustic positioning signal in and observing reflections of the signal back to the controller 210. In still another example, a combination of active and passive positioning could be used by the controller 210. For instance, the controller 210 could determine timing information associated with positioning response signals actively transmitted by respective remote devices 230 as well as reflections of the initial positioning signal off of walls, floors, or other surfaces of the area in order to estimate a layout of the area in addition to the relative positions of the remote devices 230.

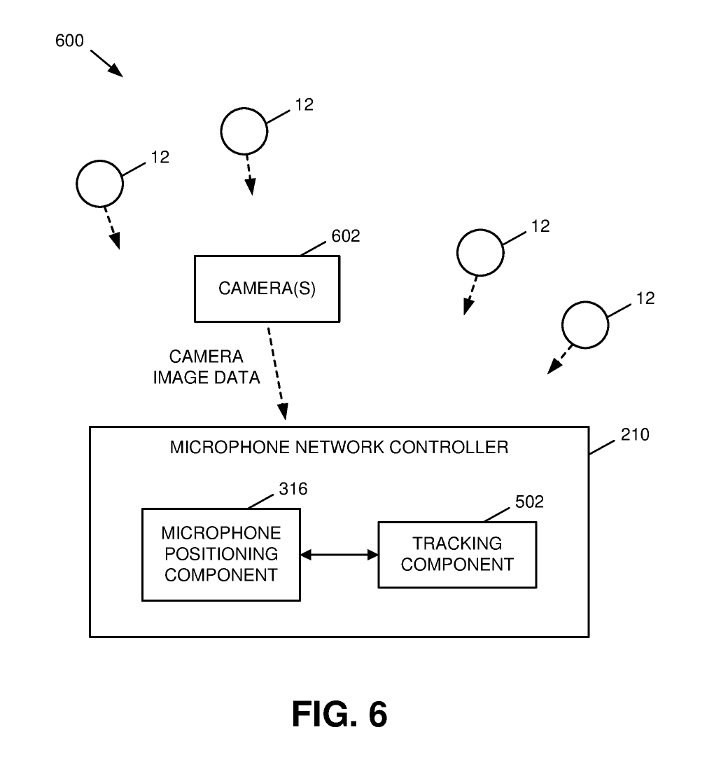

In an aspect, the controller 210 can utilize one or more other positioning techniques in addition to, or in place of, acoustic positioning. For instance, the controller 210 could utilize inertial positioning, satellite-aided positioning, visual positioning, and/or any other suitable positioning techniques to locate microphones 12, remote devices 230, and/or other objects in an associated area. An example in which visual positioning is utilized to supplement acoustic positioning is described in further detail below with respect to FIG. 6.

In another aspect, positioning of respective microphones 12 and/or remote devices 230 in an area associated with system 300 can be performed by an entity separate from the controller 210. For instance, the controller 210 can interface with a room calibration system (not shown) or other suitable computing component(s) that perform one or more of the operations described above with respect to the controller 210 and communicate the results of those operations back to the controller 210 as appropriate. In an example, a standalone room calibration system can be implemented as a software component executed by a computing device that is communicatively coupled to the controller 210. Other implementations are also possible.

In an aspect, a standalone room calibration system can collect information regarding remote devices 230 and/or microphones 12 in the area on an ongoing basis, e.g., continuously or near continuously, and provide this information to the controller 210 as appropriate. Information collected in this manner can include device locations, availability and/or authorization status for respective remote devices 230 and/or microphones 12 in the area, and/or other suitable information.

In a further aspect, one or more of the remote devices 230 and/or associated microphones 12 can be determined to have a substantially fixed position relative to the controller 210 and the surrounding area. Such devices can include, but are not limited to, microphones and/or microphone-enabled devices mounted and/or otherwise fixed to a wall, ceiling, or other structural feature of the area, large appliances (e.g., refrigerators, freezers, washing machines, etc.) that are generally installed at a fixed position within an area, or the like. In one example, positions of respective fixed devices can be determined by the controller 210 in an initial positioning operation and/or provided to the controller 210 as user input or other direct position information. Subsequently, the controller 210 can store this position information and omit repetitive positioning operations with respect to the fixed devices at a later time.

In some implementations, timing information corresponding to the controller 210 and respective remote devices 230 and/or associated microphones 12 can be synchronized via hardware and/or software in order to increase precision associated with device positioning, facilitate beamforming between microphones 12 of multiple distinct remote devices 230, and/or for other uses. In one example, timing synchronization between devices of system 300 can occur on an as-needed basis, e.g., during positioning and/or other procedures, or on an ongoing basis.

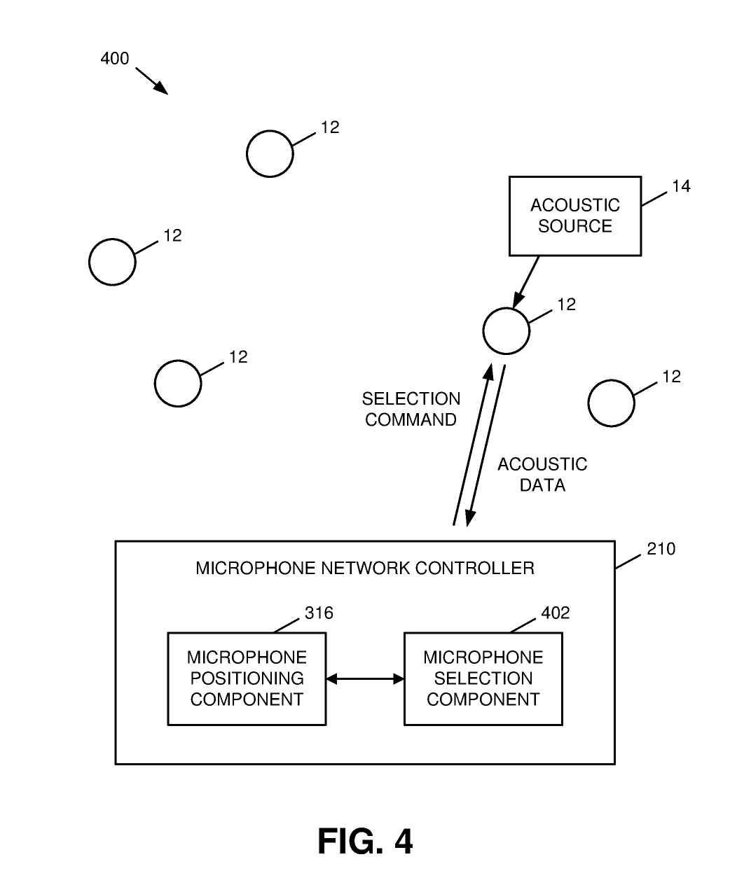

Referring next to FIG. 4, a system 400 that facilitates acoustic source positioning and microphone selection in accordance with one or more embodiments of the disclosure is illustrated. Repetitive description of like parts discussed in previous embodiments is omitted for brevity. Here, system 400 includes a microphone network controller 210 that operates in an area in which respective microphones 12 are located. The microphones 12 can be associated with remote devices 230 (not shown) and/or standalone microphones 12. Additionally, the controller 210, via the microphone positioning component 316, can determine positions of the respective microphones 12 in system 400 using techniques similar to those described above with respect to FIG. 3.

In an aspect, the controller 210, or one or more devices associated with the respective microphones 12, can identify the presence of an active acoustic source 14 in the area. The acoustic source 14 can be any source of acoustic signals or waveforms that can be interpreted (e.g., as voice, audible tones, infrasonic/ultrasonic wave patterns, etc.) and utilized by one or more applications running on at least one device in system 400.

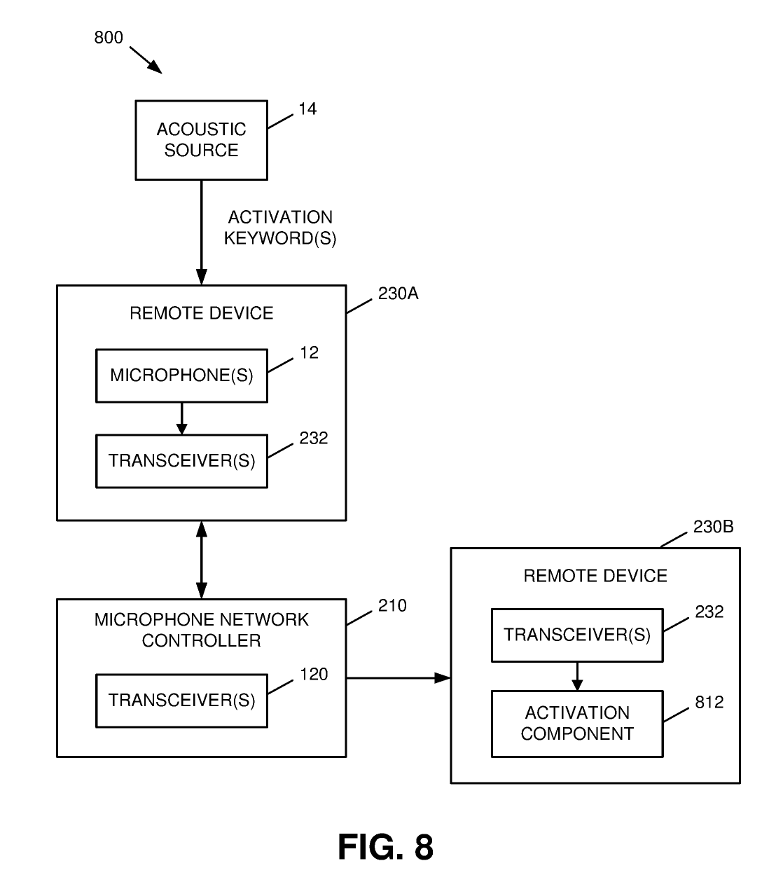

In an aspect, identification of the acoustic source 14 can be performed by the controller 210 and/or microphones 12 in response to activity by the acoustic source 14. For instance, one or more microphones 12 can detect that the acoustic source 14 has started speaking and/or otherwise initiated audio activity. Also or alternatively, the controller 210 and/or microphones 12 can be configured to identify an acoustic source 14 in response to particular keywords or phrases given by the acoustic source 14, such as “barge-in” commands for a smart speaker and/or other activation keywords. Techniques for recognizing and utilizing activation keywords are described in further detail below with respect to FIG. 8. In response to identifying the acoustic source 14 in the area, a microphone selection component 402 at the controller 210 can select one or more of the active microphones 12 in the area and instruct the selected microphones 12 to capture audio from the acoustic source 14.

In one example, the controller 210 can select active microphones 12 in the area for a given acoustic source 14 by estimating a position of the acoustic source 14 and selecting respective active microphones 12 in the area based on their proximity to the acoustic source 14. For instance, the controller 210 can utilize acoustic (e.g., infrasonic, sonic, or ultrasonic) positioning, image-aided positioning, and/or other techniques to determine an approximate location of the acoustic source 14 in a similar manner to the techniques for microphone positioning described above with respect to FIG. 3. Based on this information, the controller 210 can issue a selection command to a microphone 12 near the acoustic source (e.g., a nearest microphone, a nearest available or authorized microphone, etc.). Here, the controller 210 in FIG. 4 is shown selecting the nearest microphone 12 to the acoustic source 14 for audio capture. Other selection criteria are also possible, as will be discussed in further detail below.

In another example, the controller 210, or respective microphones 12 and/or their associated devices, can collaboratively select one or more microphones 12 to capture audio from the acoustic source 14 based on observed signal quality relative to the acoustic source 14. For instance, respective available and authorized microphones 12 can report an observed audio quality associated with the acoustic source 14 (e.g., as a signal-to-noise ratio, volume level, etc.) to the controller 210 and/or other microphones 12 in the area. Based on these observed audio quality metrics, a microphone 12 having an observed audio quality above a threshold, or a highest audio quality, can be selected to capture audio from the acoustic source 14.

In still another example, a device for which activation keywords and/or other audio information from the acoustic source 14 is intended can detect the presence of said audio and elect to capture audio from the acoustic source 14 locally without use of the controller 210 or the other microphones 12 in the area. In an aspect, a device can override the controller 210 in this manner conditionally, e.g., if an observed audio quality at the device is at least a threshold quality.

In an aspect, the controller 210, via the microphone selection component 402, can issue selection commands to multiple time-synchronized microphones 12 of a same device or different devices in system 400 to capture audio from the acoustic source 14 simultaneously or near simultaneously, such that the controller 210 can enhance the quality of the audio from the acoustic source 14 via beamforming or other techniques.

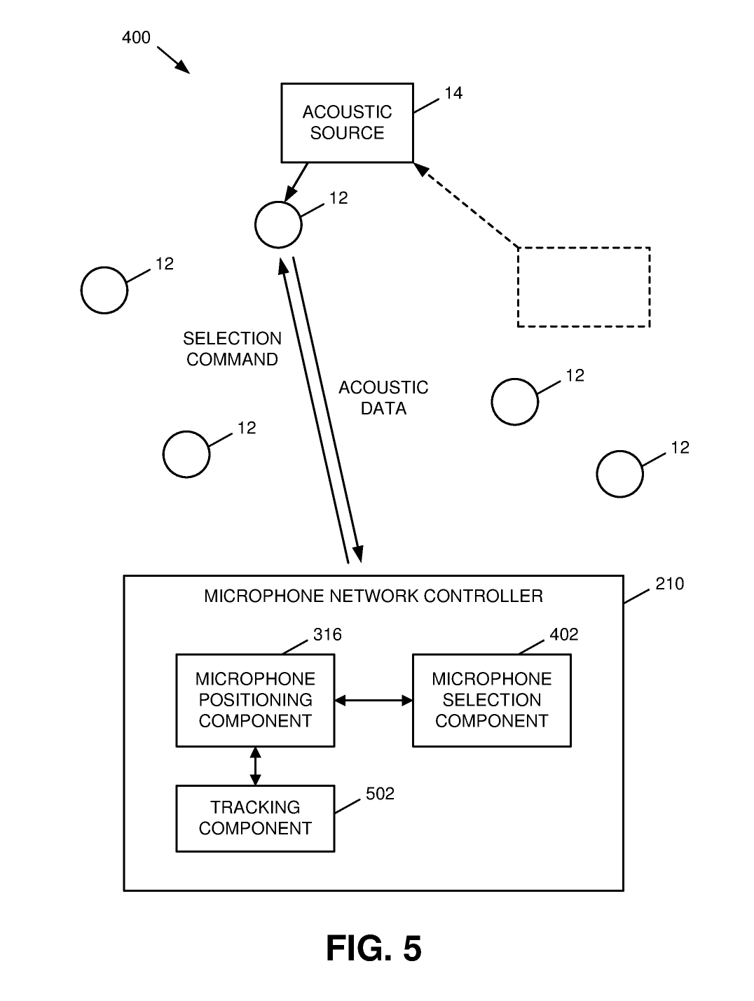

In the event that the acoustic source 14 moves within the area associated with system 400, a tracking component 502 associated with the controller 210 can track movement of the acoustic source 14 in relation to the positions of respective active microphones 12 in the area, as shown by FIG. 5. In an aspect, the tracking component 502 can track movement of the acoustic source 14 based on a series of positioning measurements, e.g., acoustic positioning measurements and/or other suitable measurements. Also or alternatively, the tracking component 502 can track movement of the acoustic source 14 based on an initial position of the acoustic source 14 and inertial and/or other data relating to its subsequent movement within the area.

In response to detecting and tracking movement of the acoustic source 14, the controller 210 can instruct a second active microphone 12 in the area to capture audio from the acoustic source 14. The second 12 microphone 12 can be the same as, or distinct from, a first active microphone 12 that was previously instructed to capture audio from the acoustic source 14 at one or more previous positions of the acoustic source 14.

In the example shown by FIG. 5, the controller 210, via the tracking component 502, instructs a nearest microphone 12 to the new position of the acoustic source 14 to capture audio from the acoustic source 14. It should be appreciated, however, that the selection shown in FIG. 5 is merely one example of a microphone selection that could be performed and that other techniques for microphone selection, such as those described above with respect to FIG. 4, could also be used.

Turning to FIG. 6, a system 600 that facilitates image-assisted positioning in a microphone mesh network in accordance with one or more embodiments of the disclosure is illustrated. Repetitive description of like parts discussed in previous embodiments is omitted for brevity. As shown in FIG. 6, system 600 includes a microphone network controller 210 that includes a microphone positioning component 316 and a tracking component 502 that can determine and monitor positions of respective active microphones 12 and/or acoustic sources in an area associated with system 600 in a similar manner to that described above with respect to FIGS. 3-5. As further shown in FIG. 6, system 600 includes a camera 602 that can be connected to the controller 210, e.g., via a network 220 as shown by system 200. In an aspect, the camera 602 can be associated with a device in system 600, e.g., a remote device 230, that is also associated with one or more of the active microphones 12. Alternatively, the camera 602 can be distinct from the microphones 12 in system 600 and/or their associated devices.

In an aspect, the microphone positioning component 316 and/or the tracking component 502 can utilize image data captured by the camera to aid in estimating the positions of one or more of the microphones 12 in the area and/or one or more acoustic sources 14. For instance, image data obtained from the camera 602 can be utilized by the controller 210 to estimate positions and/or orientations of devices, microphones 12, acoustic sources 14, etc., via one or more image processing algorithms.

In another example, the camera 602 and/or the controller 210 can generate facial recognition data based on image data captured by the camera 602 such that the controller 210 can estimate the position of an acoustic source 14 in the area, e.g., a human speaker, based on the facial recognition data. Similarly, the camera 602 and/or the controller 210 can generate gesture recognition data based on image data captured by the camera 602 such that the controller 210 can identify gestures (e.g., hand motions and/or other predefined movements) performed by a human speaker and/or other potential acoustic source 14 in the area in order to initiate audio capture and/or positioning for a given acoustic source 14 in addition to, or in place of, receiving audio from the acoustic source 14. In an aspect, generation and/or use of facial recognition data and/or gesture recognition data can be subject to authorization and/or user consent restrictions that are similar to those described above for microphone authorization with respect to FIG. 2.

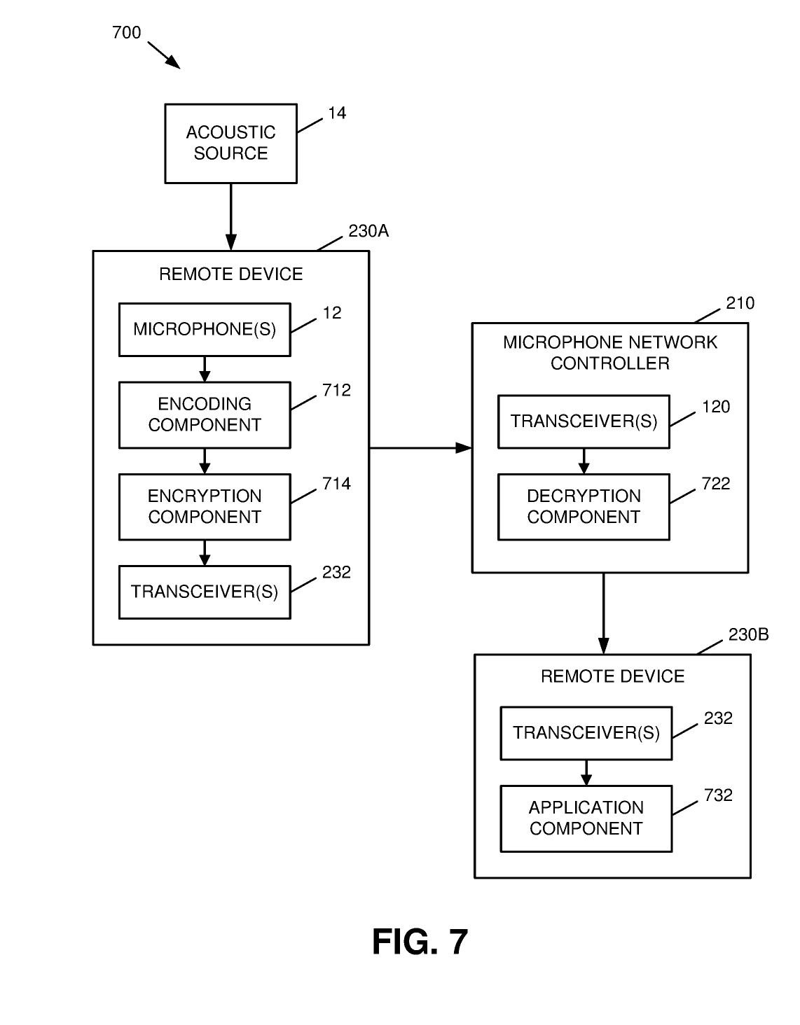

With reference now to FIG. 7, a block diagram of a system 700 that facilitates data encryption and security in a microphone mesh network in accordance with one or more embodiments of the disclosure is illustrated. Repetitive description of like parts discussed in previous embodiments is omitted for brevity. As shown by FIG. 7, system 700 includes a first remote device 230A that can capture audio from an acoustic source 14 via one or more microphones 12 in accordance with various aspects as described above.

The remote device 230A shown in system 700 includes an encoding component 712 that can modulate and/or otherwise encode audio information captured from the acoustic source 14 into one or more radio messages (e.g., for transmission over one or more networks 220). The remote device 230A further includes an encryption component 714 that can process radio message information generated by the encoding component 712 via one or more encryption algorithms to obtain an encrypted signal that includes the audio captured from the acoustic source 14. The encrypted signal(s) can subsequently be transmitted via one or more transceivers 232 to the microphone network controller 210 and/or one or more other devices.

While processing performed by the encryption component 714 is illustrated in FIG. 7 as occurring subsequent to encoding by the encoding component 712, it should be appreciated that encoding and encryption could also occur in the reverse order. In other words, the encryption component 714, in some implementations, can encrypt audio captured by the acoustic source 14 and provide the resulting encrypted audio to the encoding component 712 for encoding and subsequent transmission. Other implementations could also be used.

In an aspect, the controller 210 can receive an encrypted signal from the remote device 230A via one or more transceivers 120 that includes audio captured from the acoustic source 14. In response to receiving the encrypted signal, a decryption component 722 and/or other suitable components at the controller 210 can decrypt the encrypted signal, thereby enabling use of the captured audio for one or more applications.

In one example, an application for which the audio transmitted by the remote device 230A is intended can be located at the controller 210, and the controller 210 can locally utilize the received and decrypted signal containing the transmitted audio. Alternatively, the audio transmitted by the remote device 230A via the encrypted signal can be intended for an application running on another remote device, e.g., an application component 732 running on a distinct remote device 230B. In this case, the controller 210 can transmit the corresponding received audio signal(s) to the intended remote device 230B. For audio to be processed at a separate remote device 230B, decryption of the audio can occur at the controller 210 as described above and/or at the destination remote device 230B via techniques similar to those described above with respect to the controller 210.

Referring next to FIG. 8, a block diagram of a system 800 that facilitates smart device activation via a microphone mesh network in accordance with one or more embodiments of the disclosure is illustrated. Repetitive description of like parts discussed in previous embodiments is omitted for brevity.

System 800 as shown by FIG. 8 includes a first remote device 230A that captures audio from an acoustic source 14 via one or more microphones 12 and forwards the captured audio, e.g., in one or more radio messages, to a microphone network controller 210 as generally described with respect to the various embodiments provided above. In an aspect, an acoustic source 14 in the area can speak and/or otherwise provide respective activation keywords that are configured to cause one or more remote devices 230 in the area (e.g., smart speakers, televisions, mobile phones, etc.) to enter an active state. Such activation keywords can also be referred to as “barge-in” commands and/or by any other appropriate nomenclature.

In an aspect, the remote device 230A can respond to detecting an activation keyword from the acoustic source 14 by providing an indication to the controller 210 via a transceiver 232. The controller 210, in turn, instructing one or more microphones 12 in the area of system 800 to capture audio from the acoustic source 14 in response to detection of the activation keyword. Also or alternatively, the remote device 230A and/or the controller 210 can determine an intended device, here a remote device 230B, based on the specific activation keyword(s) provided by the acoustic source 14, such that the controller 210 can facilitate activation of the remote device 230B via an activation component 812 at the remote device 230B based on the detected activation keyword(s).

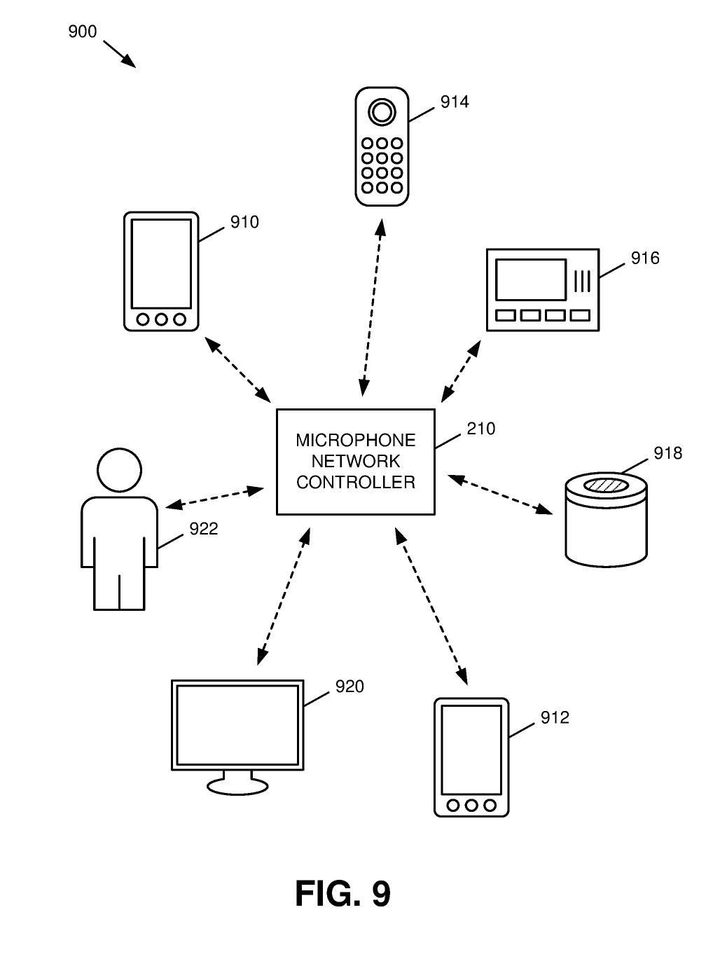

Turning to FIG. 9, an example environment in which various aspects of the microphone network controller 210 described above can operate is shown by diagram 900. In an aspect, multiple devices having local microphones can be present in an environment associated with the controller 210. For instance, the environment shown in diagram 900 includes two mobile phones 910, 912, a remote control 924, a thermostat 916, a smart speaker 918, a television 920, and one or more wearable microphones 922 (e.g., a lapel microphone, a headset microphone, etc.) worn by a person present in the environment. It should be appreciated, however, that the devices shown in diagram 900 are intended as examples of microphone-enabled devices that could be utilized and other devices could also be used in addition to and/or in place of the devices shown in diagram 900.

In an aspect, the controller 210 can have a central capability to monitor the environment for available microphones and to choose respective ones of the available microphones based on the needs of respective devices in the environment, as generally described above. For instance, the controller 210 can utilize one or more techniques as described herein to facilitate the use by a first device of a microphone in a different, nearby device. As a result, the complexity and cost of designing a single device with capability to achieve high audio quality for all of its use cases can be reduced by supplementing the audio input of the device from an external microphone.

As an example use case shown in FIG. 9, the smart speaker device 918, while having multiple microphones, can in some cases have difficulty processing audio input while music is playing loudly or other background audio is present. Accordingly, the smart speaker 918, via the controller 210, can utilize microphones in devices such as the remote control 914 or the television 920 for voice command control.

In an aspect, a device associated with the controller 210 can utilize one or more microphones in a nearby device that is connected to the controller 210 via a network 220 (e.g., a wired or wireless network). The controller 210 can determine which microphones to use, for instance, from microphones locally associated with the controller or one or more microphones in a nearby device. The controller 210 can recognize microphones in multiple nearby devices as well as standalone microphones such as a standalone body worn microphone, a microphone in a headset, etc.

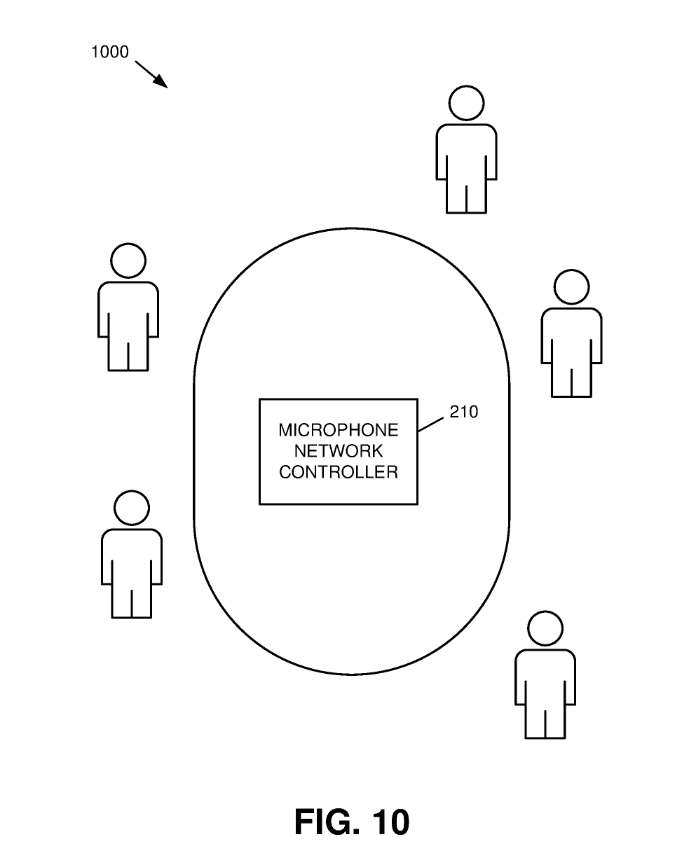

In another example environment shown by diagram 1000 in FIG. 10, a microphone network controller 210 can be used in a conference room in which respective participants can wear personal microphones with wireless communication capability. Such a microphone can be small and low power. By utilizing the controller 210 during a video or audio conference, instead of using a complex beamforming unit in the room or in a television or other device present in the room, the controller 210 can poll the microphones in the room, including personal microphones, microphones in computers, phones, wall mounted units, etc., and determine in substantially real time which microphones to access.

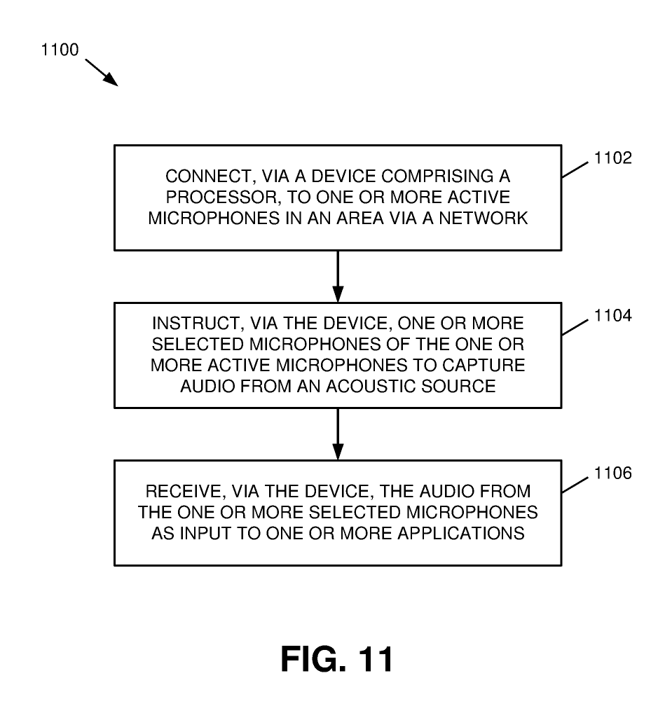

FIG. 11 as described above illustrates a method in accordance with certain aspects of this disclosure. While, for purposes of simplicity of explanation, the method is shown and described as a series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain aspects of this disclosure.

FIG. 11 illustrates a flow diagram of an example, non-limiting computer-implemented method 1100 that facilitates a microphone mesh network according to one or more embodiments described herein.

At 1102, a device operatively coupled to a processor (a controller 210 associated with a processor 110) connects to one or more active microphones (e.g., microphones 12 associated with respective remote devices 230) in an area via a network (e.g., network 220).

At 1104, the device instructs one or more selected microphones of the one or more active microphones to capture audio from an acoustic source (e.g., an acoustic source 14).

At 1106, the device receives the audio from the one or more selected microphones as input to one or more applications.

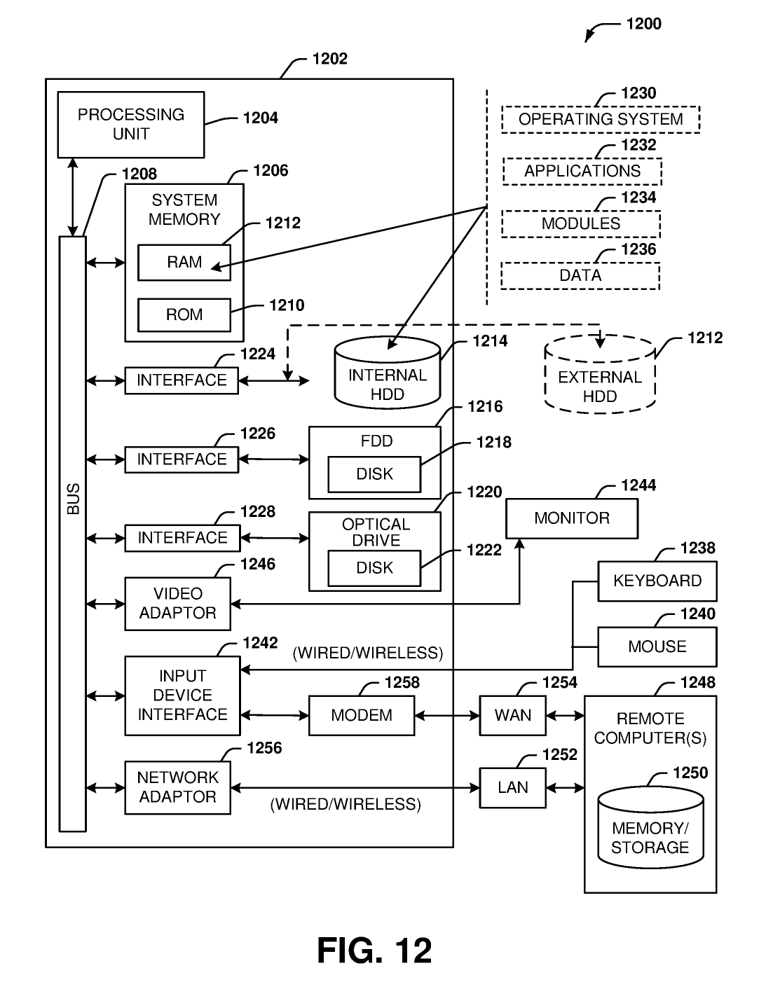

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD-ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). While the internal HDD 1214 is illustrated as located within the computer 1202, the internal HDD 1214 can also be configured for external use in a suitable chassis (not shown). The HDD 1214, magnetic FDD 1216 and optical disk drive 1220 can be connected to the system bus 1208 by an HDD interface 1224, a magnetic disk drive interface 1226 and an optical drive interface 1228, respectively. The interface 1224 for external drive implementations includes at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to an HDD, a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) can include a microphone, an infrared (IR) remote control, a joystick, a game pad, a stylus pen, touch screen or the like. These and other input devices are often connected to the processing unit 1204 through an input device interface 1242 that can be coupled to the system bus 1208, but can be connected by other interfaces, such as a parallel port, an IEEE 1394 serial port, a game port, a USB port, an IR interface, etc.

A monitor 1244 or other type of display device can be also connected to the system bus 1208 via an interface, such as a video adapter 1246. In addition to the monitor 1244, a computer typically includes other peripheral output devices (not shown), such as speakers, printers, etc.

The computer 1202 can operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1252 through a wired and/or wireless communication network interface or adapter 1256. The adapter 1256 can facilitate wired or wireless communication to the LAN 1252, which can also include a wireless access point (AP) disposed thereon for communicating with the wireless adapter 1256.

When used in a WAN networking environment, the computer 1202 can include a modem 1258 or can be connected to a communications server on the WAN 1254 or has other means for establishing communications over the WAN 1254, such as by way of the Internet. The modem 1258, which can be internal or external and a wired or wireless device, can be connected to the system bus 1208 via the input device interface 1242. In a networked environment, program modules depicted relative to the computer 1202 or portions thereof, can be stored in the remote memory/storage device 1250. It will be appreciated that the network connections shown are example and other means of establishing a communications link between the computers can be used.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

In the present specification, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should generally be construed to mean “one or more” unless specified otherwise or clear from context to be directed to a singular form.

In addition, the terms “example” and “such as” are utilized herein to mean serving as an instance or illustration. Any embodiment or design described herein as an “example” or referred to in connection with a “such as” clause is not necessarily to be construed as preferred or advantageous over other embodiments or designs. Rather, use of the terms “example” or “such as” is intended to present concepts in a concrete fashion. The terms “first,” “second,” “third,” and so forth, as used in the claims and description, unless otherwise clear by context, is for clarity only and doesn't necessarily indicate or imply any order in time.

What has been described above includes examples of one or more embodiments of the disclosure. It is, of course, not possible to describe every conceivable combination of components or methodologies for purposes of describing these examples, and it can be recognized that many further combinations and permutations of the present embodiments are possible. Accordingly, the embodiments disclosed and/or claimed herein are intended to embrace all such alterations, modifications and variations that fall within the spirit and scope of the detailed description and the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented method, comprising:
connecting, via a device comprising a processor, to one or more active microphones in an area via a network;
instructing, via the device, one or more selected microphones of the one or more active microphones to capture audio from an acoustic source; and
receiving, via the device, the audio from the one or more selected microphones as input to one or more applications.

2. The computer-implemented method of claim 1, further comprising:
identifying, via the device, the acoustic source in the area.

3. The computer-implemented method of claim 1, further comprising:
determining, via the device, positions of respective ones of the active microphones.

4. The computer-implemented method of claim 3, wherein the determining the positions of the respective ones of the active microphones comprises locating the respective ones of the active microphones in the area via acoustic positioning.

5. The computer-implemented method of claim 3, further comprising:
estimating, via the device, a position of the acoustic source;
wherein the instructing comprises selecting the one or more selected microphones based on proximity to the acoustic source.

6. The computer-implemented method of claim 1, further comprising:
connecting, via the device, to a camera in the area via the network;
wherein the estimating the position of the acoustic source comprises estimating the position of the acoustic source based on facial recognition data or gesture recognition data associated with the camera.

7. The computer-implemented method of claim 1, wherein the one or more selected microphones comprise a first selected microphone, and wherein the computer-implemented method further comprises:
tracking, via the device, movement of the acoustic source in relation to the positions of the respective ones of the active microphones; and
instructing, via the device, a second selected microphone of the one or more active microphones to capture the audio from the acoustic source in response to the tracking, wherein the second selected microphone is distinct from the first selected microphone.

8. The computer-implemented method of claim 7, wherein the acoustic positioning comprises at least one of sonic positioning, infrasonic positioning, or ultrasonic positioning.

9. The computer-implemented method of claim 1, wherein the instructing comprises instructing the one or more selected microphones to capture audio from the acoustic source in response to detection of an activation keyword by the one or more selected microphones.

10. The computer-implemented method of claim 1, wherein the receiving comprises receiving an encrypted signal comprising the audio from the one or more selected microphones, and the computer-implemented method further comprises:
decrypting, via the device, the encrypted signal.

11. The computer-implemented method of claim 1, wherein the one or more applications are associated with a remote device connected via the network, and the computer-implemented method further comprises:
transmitting, via the device, the audio to the remote device.

12. A device, comprising:
one or more processors;
a transceiver operatively coupled to the one or more processors; and
a memory operatively coupled to the one or more processors, the memory having stored thereon computer executable instructions which, when executed by the one or more processors, cause the one or more processors to:
connect to one or more active microphones in an area via the transceiver over a network;
identify an acoustic source in the area;
instruct one or more selected microphones of the one or more active microphones to capture audio from the acoustic source; and
receive, via the transceiver, the audio from the one or more selected microphones as input to one or more applications.

13. The device of claim 12, wherein the instructions further cause the one or more processors to determine positions of respective ones of the active microphones.

14. The device of claim 13, wherein the instructions further cause the one or more processors to estimate a position of the acoustic source and to select the one or more selected microphones based on proximity to the acoustic source.

15. The device of claim 14, wherein the one or more selected microphones comprise a first selected microphone, wherein the instructions further cause the one or more processors to instruct a second selected microphone of the one or more active microphones to capture the audio from the acoustic source in response to the tracking, and wherein the second selected microphone is distinct from the first selected microphone.

16. The device of claim 12, wherein the instructions further cause the one or more processors to instruct the one or more selected microphones to capture audio from the acoustic source in response to detection of an activation keyword by the one or more selected microphones.

17. The device of claim 12, wherein the one or more applications are associated with a remote device that is connected to the device via the network, and wherein the instructions further cause the one or more processors to transmit, via the transceiver, the audio to the remote device.

18. A computer program product for managing a microphone mesh network, the computer program product comprising a non-transitory computer readable storage medium having stored thereon program instructions, wherein the program instructions are executable by a processor to cause the processor to:
connect to one or more active microphones in an area via the microphone mesh network;
identify an acoustic source in the area;
instruct one or more selected microphones of the one or more active microphones to capture audio from the acoustic source; and
receive the audio from the one or more selected microphones as input to one or more applications.

19. The computer program product of claim 18, wherein the program instructions further cause the processor to:
determine positions of respective ones of the active microphones;
estimate a position of the acoustic source; and
select the one or more selected microphones based on proximity to the acoustic source.

20. The computer program product of claim 19, wherein the one or more selected microphones comprise a first selected microphone, and wherein the program instructions further cause the processor to:
track movement of the acoustic source in relation to the positions of the respective ones of the active microphones; and
instruct a second selected microphone of the one or more active microphones to capture the audio from the acoustic source in response to the tracking, wherein the second selected microphone is distinct from the first selected microphone.
